(19) United States
(12) Patent Application Publication
(10) Pub. No.: US 2006/0136121 A1
(43) Pub. Date: Jun. 22, 2006

(54) Method, system, and computer program product for conveying a changing local time zone in an electronic calendar

(75) Inventor: Jeffrey N. Eisen, Waban, MA (US)

Correspondence Address: HOFFMAN, WARNICK & D'ALESSANDRO LLC, 75 STATE ST, 14TH, ALBANY, NY, 12207, US

(73) Assignee: International Business Machines Corporation, Armonk, NY (US)

(21) Appl. No.: 11/013,816

(22) Filed: Dec. 16, 2004

(51) Int. Cl. G01C 21/00

(52) U.S. Cl. 701/200

(57) ABSTRACT

A method, system, and computer program product for conveying a changing local time zone in an electronic document such as an electronic calendar. The method comprises: providing at least one travel document containing travel information corresponding to at least one trip; determining a local time zone for each entry in the electronic document scheduled to occur during each trip, based on the travel information contained in the at least one travel document; updating the electronic document to reflect local time zone information for each entry scheduled to occur during each trip; and displaying the local time zone information in the electronic document for each entry scheduled to occur during each trip, independently of a current date.

### BACKGROUND OF THE INVENTION

1. Field of the Invention

The present invention relates generally to electronic calendars. More specifically, the present invention provides a method, system, and computer program product for conveying a changing local time zone in an electronic calendar.

2. Background Art

For someone who travels across time zones, it would be useful to be able to see a calendar in terms of a changing (as they travel) local time zone. This would allow them to determine what time an entry (e.g., appointment, meeting, etc.) is “really” scheduled. Using a pencil and paper, this is a straightforward task, where some days may not necessarily appear as 24 hour slots in a calendar. This may occur, for example, when traveling from Los Angeles to Boston, where a day might appear as only 21 hours due to the 3 hour time “loss.” When using an electronic calendar, however, it becomes more difficult to automatically track changing local time zones.

Multiple solutions are possible, each with its own drawbacks. For example:
(1) Allowing the electronic calendar to display multiple fixed time zones. This is better than nothing, but does not cover the case where more choices of time zones are required. Additionally, it doesn't let the user know for each scheduled meeting/appointment what is the local time for that event.
(2) Attaching time zone information to each meeting/appointment in the electronic calendar. For personal appointments, this may work because when one creates an appointment, they normally know where they will be when the appointment takes place. However, for a meeting where a person is an invitee, the chair might be in a different time zone (e.g., for a phone conference), and manually assigning/overriding time zones each time a meeting is accepted can be cumbersome. Additionally, if a last minute travel change is made, the time zone of each affected meeting/appointment would have to be changed.
(3) Automatically or manually determining the time zone by Global Positioning System (GPS) or changing the time zone of the user's computer operating system. This may work well when a person has arrived at their destination and needs to determine what they have scheduled at 10 AM, for example, but it is cumbersome when planning trips with possibly multiple time zone changes.

Accordingly, there is a need for a method, system, and computer program product for conveying a changing local time zone in an electronic calendar that obviates the deficiencies of the prior art.

### SUMMARY OF THE INVENTION

In general, the present invention provides a method, system, and computer program product for conveying a changing local time zone in an electronic calendar. In particular, the present invention utilizes travel information in a “travel document” to determine the local time zone for each entry in an electronic calendar, and displays information in the electronic calendar that reflects the local time zones. To this extent, each entry in the electronic calendar will reflect the local time corresponding to the scheduled physical location of the user of the electronic calendar at that time, based on the travel information provided in the travel document. For example, assume that the user of the electronic calendar is scheduled to travel from Boston (Eastern Standard Time (EST)) to San Francisco (Pacific Standard Time (PST)), travel from San Francisco to Chicago (Central Standard Time (CST)), and then return to Boston. Also assume that this information has been provided in a travel document for use by an electronic calendar. In accordance with the present invention, those entries in the electronic calendar occurring while the user is scheduled to be in Boston would be displayed in EST, those entries occurring while the user is scheduled to be in San Francisco would be displayed in PST, while those entries occurring while the user is scheduled to be in Chicago would be displayed in CST. Those entries which are not related to the travel information within the travel document are displayed in a conventional manner, typically in the user's “home” time zone.

A first aspect of the present invention provides a method for conveying a changing local time zone in an electronic document, comprising: providing at least one travel document containing travel information corresponding to at least one trip; determining a local time zone for each entry in the electronic document scheduled to occur during each trip, based on the travel information contained in the at least one travel document; updating the electronic document to reflect local time zone information for each entry scheduled to occur during each trip; and displaying the local time zone information in the electronic document for each entry scheduled to occur during each trip, independently of a current date.

A second aspect of the present invention provides a system for conveying a changing local time zone in an electronic document, comprising: a system for providing at least one travel document containing travel information corresponding to at least one trip; a system for determining a local time zone for each entry in the electronic document scheduled to occur during each trip, based on the travel information contained in the at least one travel document; a system for updating the electronic document to reflect local time zone information for each entry scheduled to occur during each trip; and a system for displaying the local time zone information in the electronic document for each entry scheduled to occur during each trip, independently of a current date.

A third aspect of the present invention provides a program product stored on a recordable medium for conveying a changing local time zone in an electronic document, which when executed comprises: program code for providing at least one travel document containing travel information corresponding to at least one trip; program code for determining a local time zone for each entry in the electronic document scheduled to occur during each trip, based on the travel information contained in the at least one travel document; program code for updating the electronic document to reflect local time zone information for each entry scheduled to occur during each trip; and program code for displaying the local time zone information in the electronic document for each entry scheduled to occur during each trip, independently of a current date.

A fourth aspect of the present invention provides a method for deploying an application for conveying a changing local time zone in an electronic document, comprising: providing a computer infrastructure being operable to: provide at least one travel document containing travel information corresponding to at least one trip; determine a local time zone for each entry in the electronic document scheduled to occur during each trip, based on the travel information contained in the at least one travel document; update the electronic document to reflect local time zone information for each entry scheduled to occur during each trip; and display the local time zone information in the electronic document for each entry scheduled to occur during each trip, independently of a current date.

A fifth aspect of the present invention provides computer software embodied in a propagated signal for conveying a changing local time zone in an electronic document, the computer software comprising instructions to cause a computer system to perform the following functions: provide at least one travel document containing travel information corresponding to at least one trip; determine a local time zone for each entry in the electronic document scheduled to occur during each trip, based on the travel information contained in the at least one travel document; update the electronic document to reflect local time zone information for each entry scheduled to occur during each trip; and display the local time zone information in the electronic document for each entry scheduled to occur during each trip, independently of a current date.

### BRIEF DESCRIPTION OF THE DRAWINGS

These and other features of this invention will be more readily understood from the following detailed description of the various aspects of the invention taken in conjunction with the accompanying drawings in which:

FIGS. 1-2 depict illustrative travel documents in accordance with an embodiment of the present invention.

FIG. 3 depicts a illustrative GUI for entering travel information into a travel document in accordance with an embodiment of the present invention.

FIG. 4 depicts a system for conveying a changing local time zone in an electronic calendar in accordance with an embodiment of the present invention.

FIGS. 5-9 provide several examples depicting how an electronic calendar can be updated to reflect local time zone information in accordance with an embodiment of the present invention.

FIG. 10 a flow diagram illustrating the process flow of a method in accordance with an embodiment of the present invention.

FIG. 11 depicts a computer system for implementing a method in accordance with an embodiment of the present invention.

The drawings are merely schematic representations, not intended to portray specific parameters of the invention, and are not necessarily to scale. The drawings are intended to depict only typical embodiments of the invention, and therefore should not be considered as limiting the scope of the invention. In the drawings, like numbering represents like elements.

### DETAILED DESCRIPTION OF THE INVENTION

As indicated above, the present invention provides a method, system, and computer program product for conveying a changing local time zone in an electronic calendar. In particular, the present invention introduces a new type of document into an electronic calendar—a “travel document.” This is in addition to the standard calendar document types such as appointment, meeting, all-day event, etc. Each travel document contains travel information that includes at least one location transition between time zones. Using a set of one or more of these travel documents, it is possible to determine the local time zone for each entry in a user's electronic calendar. This data can then be used by the electronic calendar to provide local time zone information, such that each entry in the electronic calendar will reflect the local time corresponding to the scheduled physical location of the user of the electronic calendar at that time.

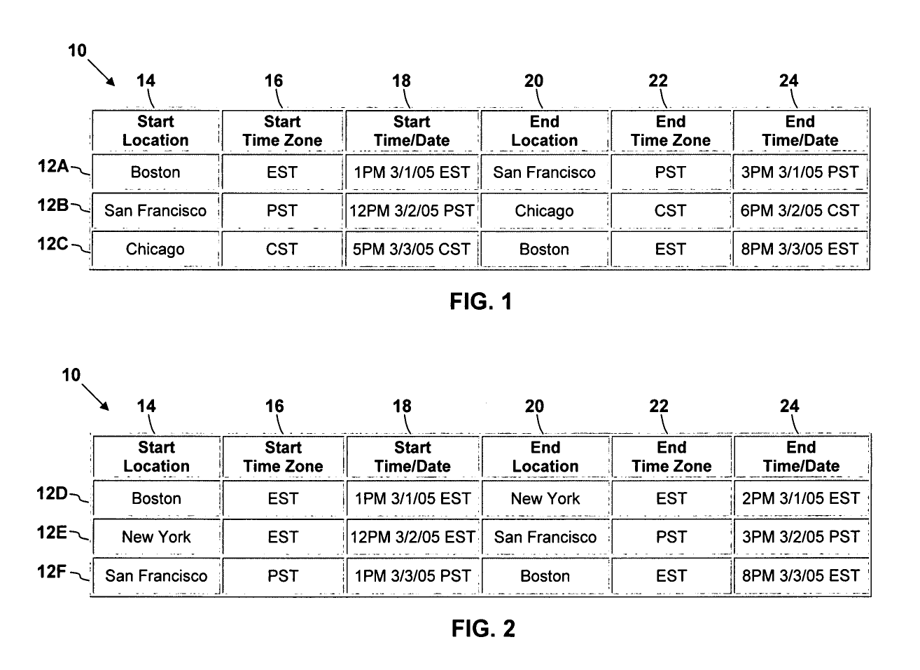

An illustrative travel document 10 is depicted in FIG. 1. As shown, the travel document 10 provides travel information for one or more “trips” 12 (i.e., trips 12A-12C), each with a start location 14, start time zone 16, start time/date 18, end location 20, end time zone 22, and end time/date 24. In this example, the travel document 10 comprises three trips 12A, 12B, 12C (i.e., a first trip 12A from Boston to San Francisco, a second trip 12B from San Francisco to Chicago, and a third trip 12C from Chicago to Boston).

In the travel document 10 illustrated in FIG. 1, it should be noted that each trip 12A, 12B, and 12C comprises a transition between different time zones. That is, the trip 12A comprises a transition between EST and PST, the trip 12B comprises a transition between PST and CST, while the trip 12C comprises a transition between CST and EST. It should also be noted, however, that one or more of the trips 12 provided in a travel document 10 may comprise travel within the same time zone. An example of such a travel document 10 is illustrated in FIG. 2. In this case, the travel document 10 comprises a first trip 12D from Boston to New York (i.e., EST to EST), a second trip 12E from New York to San Francisco (EST to PST), and a third trip 12F from San Francisco to Boston (PST to EST). In general, a trip 12 in accordance with the present invention comprises travel between different locations, which may or may not be in different time zones, while a travel document 10 comprises at least one trip that transitions across at least one time zone.

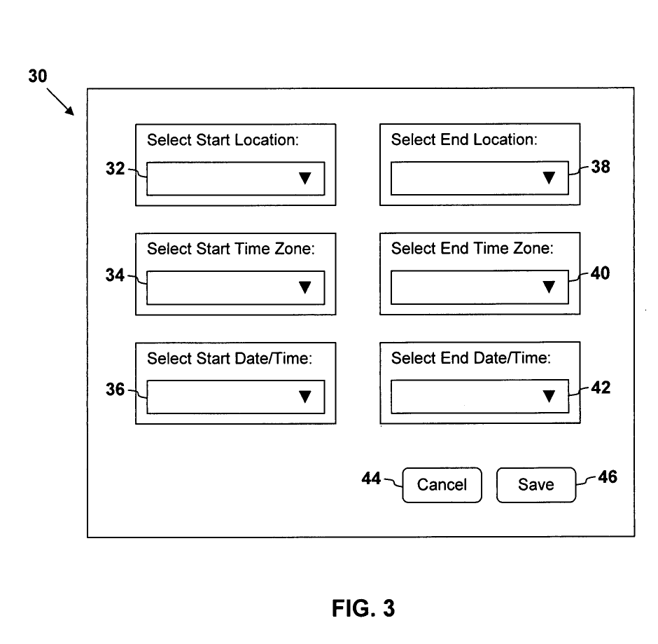

Data can be entered into a travel document 10 using, for example, a graphical user interface (GUI) or other suitable now known or later developed technique. An illustrative GUI 30 is depicted in FIG. 3. Such a GUI 30 can be provided as a part of an electronic calendar program, as a separate data entry program, etc. As shown, GUI 30 includes a field 32 for entering the start location 14 of a trip, a field 34 for entering the start time zone 16 of the trip, and a field 36 for entering the start time/date 18 of the trip. Also provided are corresponding fields 38, 40, and 42 for entering the end location 20, end time zone 22, and end time/date 24 of the trip, respectively. Other standard GUI-type buttons such as cancel 44, save 46, etc., can also be provided. Each of the fields in GUI 30 can comprise drop-down choice menus as shown, or can comprise any other suitable type of data entry field that can be used to enter data into a GUI, form, document, etc. The start time/date 18 and end time/date 24 entered in the start time/date field 36 and end time/date field 42, respectfully, in GUI 30 are transformed to a canonical time zone such as Greenwich Mean Time (GMT).

It should be noted that the start location 14 is not strictly necessary in the travel document 10—only a start time zone 16 is needed. Thus, the start location field 32 in the GUI 30 may not be required. The same is true for the end location 20 in the travel document 10—only an end time zone 18 is needed. However, use of the start location field 32 and end location field 38 allows a richer GUI 30 that provides a closer match to a typical user's mental travel model (e.g., an airline itinerary). It should also be noted that the start time zone field 34 and the end time zone field 40 in the GUI 30 can be automatically filled in based on the data entered into the start location field 32 and end location field 38, respectfully. This can be accomplished, for example, using a city/country to time zone lookup.

In the travel document 10 described above, each trip 12 includes a start location 14 and an end location 20. In an alternate embodiment of the present invention, the start location 14 is not included in the travel document 10. In this case, the start location 14 can be implied from where the “previous” trip in the electronic calendar “left” the user (i.e., using the end location 20 of the previous trip). If only an end location 20 is provided, then travel would essentially be instantaneous, marked by a specific moment when time zones change as opposed to an “air travel” model where it is gradual over a flight.

The start time/date 18 in the travel documents 10 depicted in FIGS. 1 and 2 is shown as including the same time zone information as that provided by the start time zone 16. For example, in the trip 12A included in the travel document 10 of FIG. 1, the start time zone 16 is “EST,” while the start time/date 18 is “1 PM Mar. 1, 2005 EST.” Although this duplicative time zone information is not necessary, it can be provided in the start time/date 18 for clarity.

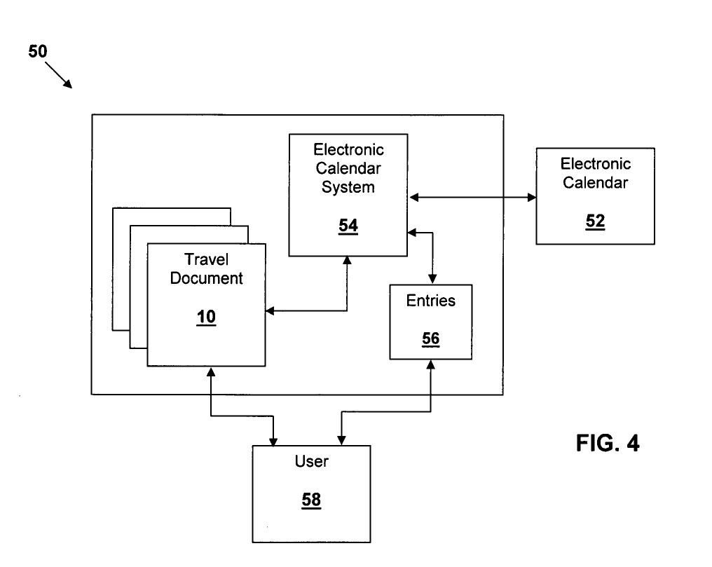

A system 50 for conveying a changing local time zone in an electronic calendar 52 in accordance with an embodiment of the present invention is illustrated in FIG. 4. The system 50 comprises an electronic calendar system 54 for generating the electronic calendar 52, and for updating the electronic calendar 52 based on travel information in at least one travel document 10 generated by a user 58. In particular, the electronic calendar 52 is updated by the electronic calendar system 54, based on the travel information in the at least one travel document 10, such that each entry 56 in the electronic calendar will reflect the local time corresponding to the scheduled physical location of the user 58 of the electronic calendar 52 at that time.

Examples of entries 56 in an electronic calendar for a user 58 having a travel itinerary corresponding to the travel document 10 illustrated in FIG. 1 are listed below.

(A) Tuesday, Mar. 1, 2005:
(1) 9:00 AM EST—Meeting with East Coast Manager;
(2) 11:00 AM EST—Car to Airport;
(3) 1:00 PM EST—Flight to San Francisco;
(4) 1:00 PM PST—Arrive in San Francisco;
(5) 2:00 PM PST—Meeting with CEO; and
(6) 5:00 PM PST—Dinner with John Doe.

(B) Wednesday, Mar. 2, 2005:
(1) 8:00 AM PST—Meeting with West Coast Manager;
(2) 10:00 AM PST—Car to Airport;
(3) 12:00 PM PST—Flight to Chicago;
(4) 6:00 PM CST—Arrive in Chicago; and
(5) 8:00 PM CST—Dinner with Joe Jones.

(C) Thursday, Mar. 3, 2005:
(1) 7:00 AM CST—Breakfast Meeting with Central Manager;
(2) 12:00 PM CST—Lunch with Jane Doe;
(3) 2:00 PM CST—Car to Airport;
(4) 4:00 PM CST—Flight to Boston; and
(5) 7:00 PM EST—Arrive in Boston.
   Each of these entries 56 are entered into the electronic calendar system 54 by the user 58 in a conventional manner and are stored in terms of a canonical time zone such as GMT.

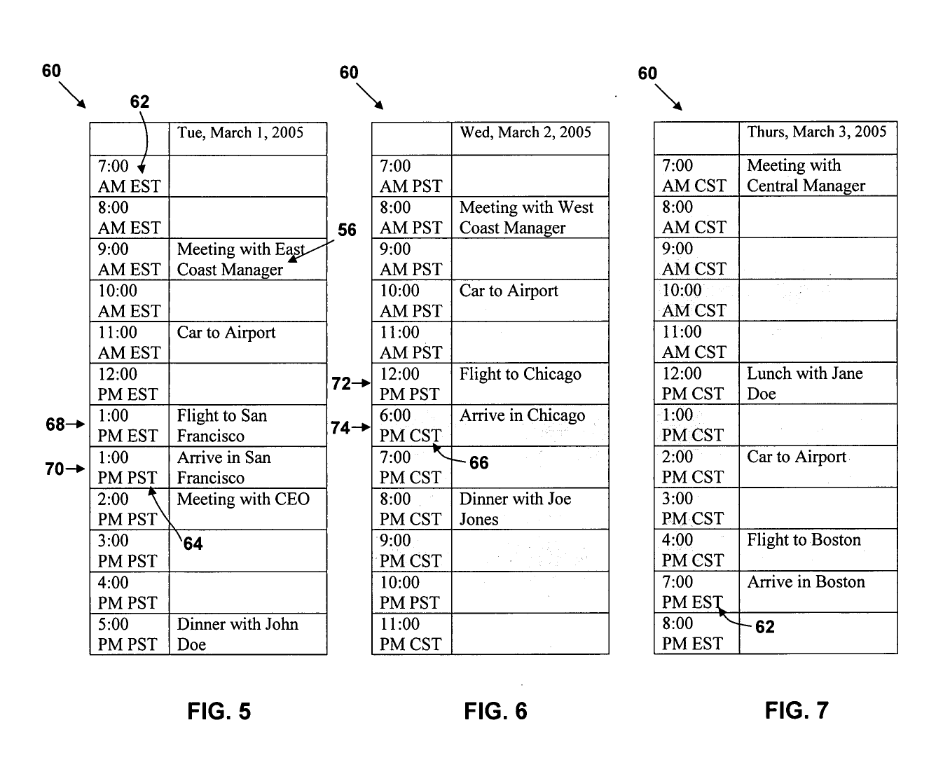

When entries 56 such as those listed above are displayed using prior art electronic calendar systems, it can be difficult for a user to track changing local time zones in an electronic calendar. This problem is exacerbated when the user is a frequent traveler and the travel transitions multiple time zones. The present invention obviates this and other problems of prior art electronic calendar systems by conveying a changing local time zone in the electronic calendar 52. An example of how the above-listed entries 56 could be displayed in an electronic calendar 52 in accordance with the present invention is illustrated in FIGS. 5-7.

FIGS. 5-7 illustrate grid-type day views 60 of the electronic calendar 52 for Tuesday, Mar. 1, 2005, Wednesday, Mar. 2, 2005, and Thursday, Mar. 3, 2005, respectively, produced in accordance with the travel information provided in the travel document 10 of FIG. 1. As shown, while the user 58 is scheduled to be in Boston, the entries 56 include indicators informing the user 58 of the local time zone corresponding to Boston. Possible indicators can include, for example, a label 62 “EST” and/or a particular shading/color (i.e., 0% shading). Many other types of indicators are possible. Similarly, while the user is scheduled to be in San Francisco, the entries 56 include a label 64 “PST” and a second shading (i.e., 10% shading), and while the user is scheduled to be in Chicago, the entries 56 include a label 66 “CST” and a third shading (i.e., 20% shading). Thus, the user 58 can easily determine from the indicators provided by the electronic calendar 52 local time zone information corresponding to his/her scheduled physical location at any given time. It can be seen from FIGS. 5-7 that the entries 56 occurring while the user 58 is scheduled to be in Boston, San Francisco, and Chicago are all simultaneously (and automatically) displayed in the electronic calendar 52 in Boston time, San Francisco time, and Chicago time, respectfully, based on the travel information provided in the travel document 10 shown in FIG. 1. This is accomplished without having to manually change the time zone in a UI of the device (e.g., computer) on which the electronic calendar 52 is generated. Also, the user 58 can view the local time zone information for each of the entries 56 at any time after generating the travel document 10 (i.e., before, during, and after the scheduled dates of the entries 56), independently of the current date.

In FIG. 5, it can be seen that on Tuesday, Mar. 1, 2005, the grid-type day view 60 of the electronic calendar 52 includes two 1:00 PM slots—a 1:00 PM EST slot 68 and a 1:00 PM PST slot 70. This occurs because the user 58 is traveling (i.e., flying) in a westerly direction and because of the three hour time difference between EST and PST time zones. It can also be seen from the grid-type view 60 for Wednesday, Mar. 2, 2005, that time slots are skipped between the 12:00 PM PST slot 72 and the 6:00 PM CST slot 74. This occurs because the user 58 is traveling (i.e., flying) in an easterly direction and because of the two hour time difference between the PST and CST time zones. Time slots are also skipped in the grid-type view 60 for Thursday, Mar. 3, 2005.

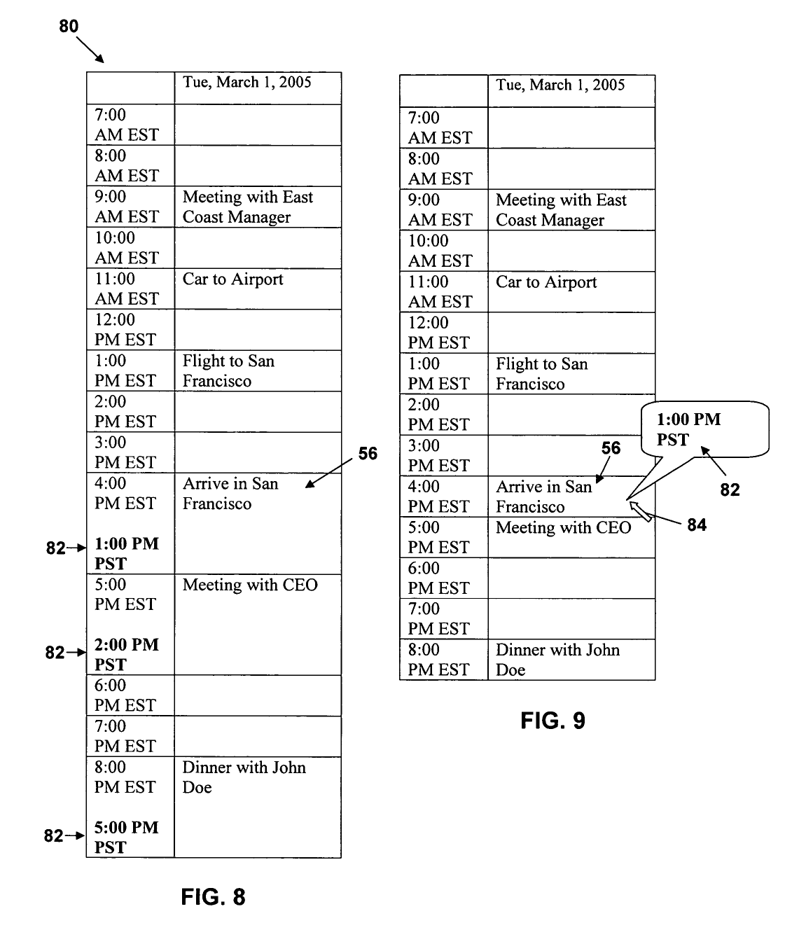

In another embodiment of the present invention, as shown in FIG. 8, a fixed grid 80 (relative to a stable “home” time zone) is provided. In the fixed grid 80, each entry 56 in the electronic calendar 52 is displayed in terms of the home time zone (EST in this case). In addition, for each scheduled entry 56 that is scheduled to occur while the user 58 is traveling outside the home time zone (as determined from the travel information provided by at least one travel document 10), corresponding local time zone information 82 is also displayed on the fixed grid 80. In FIG. 8, the travel information listed in the travel document 10 of FIG. 1 for Tuesday, Mar. 1, 2005 is used to generate the local time zone information 82.

Other techniques for displaying the local time zone information can also be used. For example, as shown in FIG. 9, local time zone information 82 can be provided (as determined from the travel information provided by at least one travel document 10) using a mouse hover 84 over a scheduled entry 56, by right clicking, by pressing a predefined key combination on a keyboard, or using any now known or later developed selection technique. In FIG. 9, the travel information listed in the travel document 10 of FIG. 1 for Tuesday, Mar. 1, 2005 is again used to generate the local time zone information 82.

Using the present invention, changed travel plans can easily be accommodated by changing, adding, and/or deleting one or more travel documents 10. Then, after performing a display refresh, the changed travel plans will be reflected in the electronic calendar 52.

The travel documents 10 could be stored separately from the standard data used by the electronic calendar system 54 to generate the electronic calendar 52. This would allow the present invention to support a shared calendar, and would allow more than one user to share appointments, meetings, etc., but have different travel plans (i.e., use different travel documents 10).

The time zone information provided when entering entries 56 into the electronic calendar 52 can be used by the system 50 to generate a “hint” to the user 58 that a travel document 10 might be warranted. For example, if an entry is scheduled to occur at 12:00 PM PST on Jan. 1, 2004 and none of the existing travel documents 10 include travel information corresponding to this entry, then the system 50 can ask the user 58 if he/she would like to provide a travel document 10. A dialog provided by the system 50 to the user 58 in this case could comprise, for example:

“You have provided an entry in Pacific Standard Time. There is no currently no travel document indicating that you will be located in this time zone at the time of the entry. Would you like to create one now . . . YES/NO.”

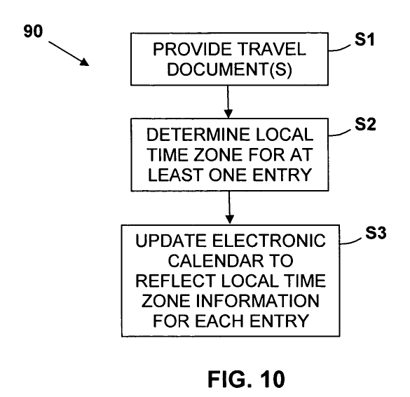

A flow diagram 90 of an algorithm for conveying a changing local time zone in an electronic calendar in accordance with an embodiment of the present invention is illustrated in FIG. 10. In step S1, at least one travel document containing travel information is provided. In step S2, a local time zone for at least one entry in an electronic calendar is determined, based on the travel information provided in the at least one travel document. In step S3, the electronic calendar is updated to reflect local time zone information for the at least one entry.

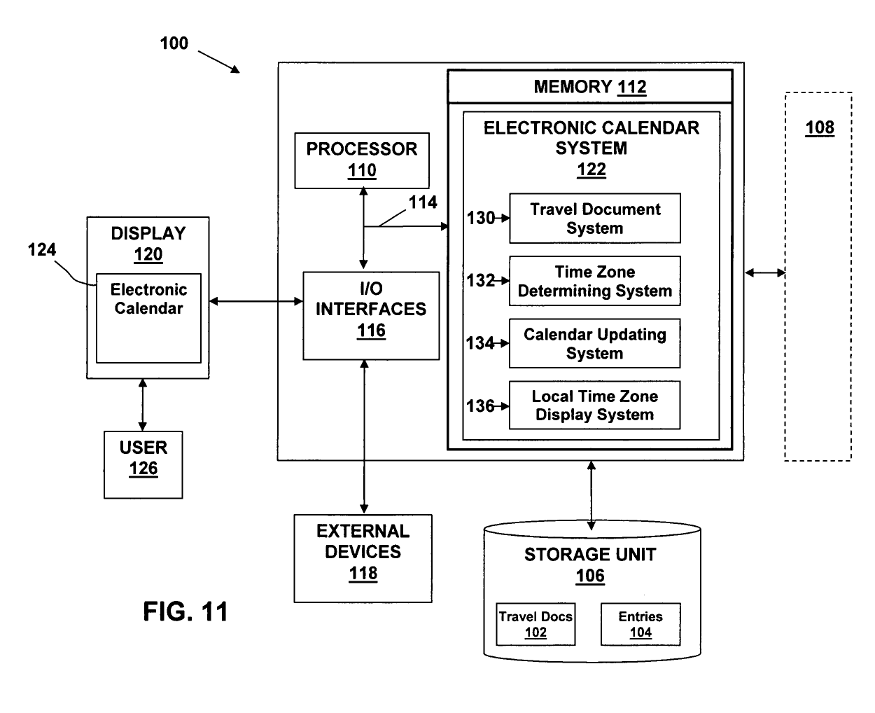

Referring now to FIG. 11, there is illustrated a computer system 100 for conveying a changing local time zone in an electronic calendar in accordance with the present invention. Computer system 100 is intended to represent any type of computerized system capable of implementing the methods of the present invention. For example, computer system 100 may comprise a desktop computer, laptop, workstation, server, PDA, cellular phone, pager, etc.

Travel documents 102, calendar entries 104, and other data used in the practice of the present invention can be stored locally to computer system 100, for example, in storage unit 106, and/or may be provided to computer system 100 over a network 108. Storage unit 106 can be any system capable of providing storage for data and information under the present invention. As such, storage unit 106 may reside at a single physical location, comprising one or more types of data storage, or may be distributed across a plurality of physical systems in various forms. In another embodiment, storage unit 106 may be distributed across, for example, a local area network (LAN), wide area network (WAN) or a storage area network (SAN) (not shown).

Network 108 is intended to represent any type of network over which data can be transmitted. For example, network 108 can include the Internet, a wide area network (WAN), a local area network (LAN), a virtual private network (VPN), a WiFi network, or other type of network. To this extent, communication can occur via a direct hardwired connection or via an addressable connection in a client-server (or server-server) environment that may utilize any combination of wireline and/or wireless transmission methods. In the case of the latter, the server and client may utilize conventional network connectivity, such as Token Ring, Ethernet, WiFi or other conventional communications standards. Where the client communicates with the server via the Internet, connectivity could be provided by conventional TCP/IP sockets-based protocol. In this instance, the client would utilize an Internet service provider to establish connectivity to the server.

As shown in FIG. 11, computer system 100 generally includes a processor 110, memory 112, bus 114, input/output (I/O) interfaces 116 and external devices/resources 118. Processor 110 may comprise a single processing unit, or may be distributed across one or more processing units in one or more locations, e.g., on a client and server. Memory 112 may comprise any known type of data storage and/or transmission media, including magnetic media, optical media, random access memory (RAM), read-only memory (ROM), etc. Moreover, similar to processor 110, memory 112 may reside at a single physical location, comprising one or more types of data storage, or be distributed across a plurality of physical systems in various forms.

I/O interfaces 116 may comprise any system for exchanging information to/from an external source. External devices/resources 118 may comprise any known type of external device, including speakers, a CRT, LED screen, handheld device, keyboard, mouse, voice recognition system, speech output system, printer, monitor/display (e.g., display 120), facsimile, pager, etc.

Bus 114 provides a communication link between each of the components in computer system 100, and likewise may comprise any known type of transmission link, including electrical, optical, wireless, etc. In addition, although not shown, additional components, such as cache memory, communication systems, system software, etc., may be incorporated into computer system 100.

Shown in memory 112 is electronic calendar system 122, which can be any known or later developed system/program capable of providing electronic calendaring capabilities. The electronic calendar system 122 provides a user interface (not shown) for displaying an electronic calendar 124 to a user 126 on the display 120. The electronic calendar system 122 includes a system 130 for providing at least one travel document 102 containing travel information corresponding to at least one trip, a system 132 for determining a local time zone for each entry 104 in the electronic calendar 124 scheduled to occur during each trip, based on the travel information contained in the at least one travel document 102, a system 134 for updating the electronic calendar 124 to reflect local time zone information for each entry 104 scheduled to occur during each trip, and a system 136 for displaying the local time zone information in the electronic calendar 124 for each entry 104 scheduled to occur during each trip, independently of a current date. The systems 122, 130, 132, 134, and 136 within memory 112 may be provided as a computer program product(s).

It should be appreciated that the teachings of the present invention could be offered as a business method on a subscription or fee basis. For example, computer system 100 could be created, maintained, supported, and/or deployed by a service provider that offers the functions described herein for customers. That is, a service provider could be used to convey a changing local time zone in an electronic calendar, as describe above. It should also be understood that the present invention can be realized in hardware, software, a propagated signal, or any combination thereof. Any kind of computer/server system(s)—or other apparatus adapted for carrying out the methods described herein—is suited. A typical combination of hardware and software could be a general purpose computer system with a computer program that, when loaded and executed, carries out the respective methods described herein. Alternatively, a specific use computer, containing specialized hardware for carrying out one or more of the functional tasks of the invention, could be utilized. The present invention can also be embedded in a computer program product or a propagated signal, which comprises all the respective features enabling the implementation of the methods described herein, and which—when loaded in a computer system—is able to carry out these methods. Computer program, propagated signal, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of this invention has been presented for purposes of illustration and description. It is not intended to be exhaustive or to limit the invention to the precise form disclosed, and obviously, many modifications and variations are possible. For example, a travel document 10 could be used as an automatic feed into various availability/location indicators for an individual, including, for instance:

(A) Instant Messaging status—“Jeff is online and in San Francisco” or “Jeff is currently in-transit to Paris”; or

(B) Out of Office mail replies and/or voicemail outgoing messages—“Jeff is in Chicago and will return on March 14.” This could even be taken further (assuming detailed itinerary information in the travel document 10 connected to a travel data feed) to an automatically generated message such as “Jeff is currently in-transit to Paris scheduled to arrive at 6 PM, but his flight is 1 hour late.” Without a travel document 10, an electronic calendar has enough information for simple availability/location indicators such as “Jeff is in a meeting until 4 PM.” Use of a travel document 10 helps greatly, however, with both locational information (where you actually are) and long time spans (a 2 week trip which contains many separate meetings or possibly no meetings). Such modifications and variations that may be apparent to a person skilled in the art are intended to be included within the scope of this invention as defined by the accompanying claims.

We claim:

1. A method for conveying a changing local time zone in an electronic document, comprising:
providing at least one travel document containing travel information corresponding to at least one trip;
determining a local time zone for each entry in the electronic document scheduled to occur during each trip, based on the travel information contained in the at least one travel document;
updating the electronic document to reflect local time zone information for each entry scheduled to occur during each trip; and
displaying the local time zone information in the electronic document for each entry scheduled to occur during each trip, independently of a current date.

2. The method of claim 1, wherein the electronic document comprises an electronic calendar.

3. The method of claim 1, wherein at least one of the trips comprises a location transition between time zones.

4. The method of claim 1, wherein the travel information for each trip comprises:
a start time zone; and
an end time zone.

5. The method of claim 4, wherein the travel information for each trip further comprises at least one of a start location, a start time/date, an end location, and an end time/date.

6. The method of claim 1, further comprising a graphical user interface (GUI) for providing the at least one travel document.

7. The method of claim 1, wherein the local time zone information for each entry comprises at least one of an indicator of the local time zone and a local time for the entry.

8. A system for conveying a changing local time zone in an electronic document, comprising:
a system for providing at least one travel document containing travel information corresponding to at least one trip;
a system for determining a local time zone for each entry in the electronic document scheduled to occur during each trip, based on the travel information contained in the at least one travel document;
a system for updating the electronic document to reflect local time zone information for each entry scheduled to occur during each trip; and
a system for displaying the local time zone information in the electronic document for each entry scheduled to occur during each trip, independently of a current date.

9. The system of claim 8, wherein the electronic document comprises an electronic calendar.

10. The system of claim 8, wherein at least one of the trips comprises a location transition between time zones.

11. The system of claim 8, wherein the travel information for each trip comprises:
a start time zone; and
an end time zone.

12. The system of claim 11, wherein the travel information for each trip further comprises at least one of a start location, a start time/date, an end location, and an end time/date.

13. The system of claim 8, further comprising a graphical user interface (GUI) for providing the at least one travel document.

14. The system of claim 8, wherein the local time zone information for each entry comprises at least one of an indicator of the local time zone and a local time for the entry.

15. A program product stored on a recordable medium for conveying a changing local time zone in an electronic document, which when executed comprises:
program code for providing at least one travel document containing travel information corresponding to at least one trip;
program code for determining a local time zone for each entry in the electronic document scheduled to occur during each trip, based on the travel information contained in the at least one travel document;
program code for updating the electronic document to reflect local time zone information for each entry scheduled to occur during each trip; and
program code for displaying the local time zone information in the electronic document for each entry scheduled to occur during each trip, independently of a current date.

16. The program product of claim 15, wherein the electronic document comprises an electronic calendar.

17. The program product of claim 15, wherein at least one of the trips comprises a location transition between time zones.

18. The program product of claim 15, wherein the travel information for each trip comprises:
a start time zone; and
an end time zone.

19. The program product of claim 18, wherein the travel information for each trip further comprises at least one of a start location, a start time/date, an end location, and an end time/date.

20. The program product of claim 15, further comprising a graphical user interface (GUI) for providing the at least one travel document.

21. The program product of claim 15, wherein the local time zone information for each entry comprises at least one of an indicator of the local time zone and a local time for the entry.

22. A method for deploying an application for conveying a changing local time zone in an electronic document, comprising:
providing a computer infrastructure being operable to:
provide at least one travel document containing travel information corresponding to at least one trip;
determine a local time zone for each entry in the electronic document scheduled to occur during each trip, based on the travel information contained in the at least one travel document;
update the electronic document to reflect local time zone information for each entry scheduled to occur during each trip; and
display the local time zone information in the electronic document for each entry scheduled to occur during each trip, independently of a current date.

23. Computer software embodied in a propagated signal for conveying a changing local time zone in an electronic document, the computer software comprising instructions to cause a computer system to perform the following functions:
provide at least one travel document containing travel information corresponding to at least one trip;
determine a local time zone for each entry in the electronic document scheduled to occur during each trip, based on the travel information contained in the at least one travel document;
update the electronic document to reflect local time zone information for each entry scheduled to occur during each trip; and
display the local time zone information in the electronic document for each entry scheduled to occur during each trip, independently of a current date.
